(19) United States
(12) Patent Application Publication
(10) Pub. No.: US 2025/0272628 A1
(43) Pub. Date: Aug. 28, 2025

(54) MAINTENANCE TASK ASSIGNMENT DEVICE AND METHOD AND NON-TRANSITORY COMPUTER READABLE MEDIUM THEREFOR

(71) Applicant: LITE-ON TECHNOLOGY CORPORATION, Taipei (TW)

(72) Inventor: Chih-Yen WU, Taipei (TW)

(21) Appl. No.: 18/953,128

(22) Filed: Nov. 20, 2024

Related U.S. Application Data
(60) Provisional application No. 63/557,629, filed on Feb. 26, 2024.

(30) Foreign Application Priority Data
Jul. 26, 2024 (TW) 113127806

(51) Int. Cl. G06Q 10/0631; G06F 21/60; G06Q 10/20

(52) U.S. Cl. CPC G06Q 10/063112; G06F 21/602; G06Q 10/20

(57) ABSTRACT

A maintenance task assignment device is provided. An assignment database stores past maintenance records. An assignment filtering module receives a maintenance case in a task list, and search the past maintenance records to obtain a candidate team leader list. The code generation module generates a group code. The team management module receives a selection command for a designated team leader chosen from the candidate team leader list. The team management module instructs the code generation module to generate the group code based on a team leader identity data entry in response to verifying that the selection command for the designated team leader matches the team leader identity data entry sent from a first user device of the designated team leader. The group code is displayed on the first user device, allowing the group code to be scanned by second user devices of team members to form a task team.

This application claims the benefit of U.S. Provisional application Ser. No. 63/557,629, filed Feb. 26, 2024, and Taiwan application Serial No. 113127806, filed Jul. 26, 2024, the subject matter of which is incorporated herein by reference.

### TECHNICAL FIELD

The disclosure relates in general to a maintenance task assignment device and method and a non-transitory computer readable medium therefor.

### BACKGROUND

Currently, maintenance operations for some large-scale equipment or public works are often outsourced, and these maintenance tasks are primarily carried out by teams having a number of maintenance technicians. Therefore, the maintenance technicians need to cooperate closely, understanding each other's maintenance progress and status to improve efficiency.

However, in existing practices, the daily attendance of maintenance technicians is difficult to track, and this industry has high turnover rate. The actual maintenance technicians available are often only confirmed on the day of the task. Then, the maintenance technicians are assigned and adjusted manually. This makes the team organization difficult and limits effective management of maintenance technicians.

Consequently, the development of an assignment management technique to flexibly adjust the members of the team, effectively track the status of the maintenance technicians, and improve maintenance efficiency has become a pressing issue in the industry.

### SUMMARY

According to a first aspect of the present invention, a maintenance task assignment device is provided. The device includes an assignment database, an assignment filtering module, a code generation module, and a team management module. The assignment database is configured to store a number of past maintenance records. The assignment filtering module is configured to be communicatively connected to the assignment database to receive a maintenance case in a task list, and search the past maintenance records in the assignment database to obtain a candidate team leader list based on the past maintenance records. The code generation module is configured to generate a group code. The team management module is configured to be communicatively connected to the code generation module and receive a selection command for a designated team leader chosen from the candidate team leader list. The team management module instructs the code generation module to generate the group code based on a team leader identity data entry in response to verifying that the selection command for the designated team leader matches the team leader identity data entry sent from a first user device of the designated team leader. The group code is displayed on the first user device of the designated team leader, allowing the group code to be scanned by a number of second user devices of a number of team members to form a task team.

According to a second aspect of the present invention, a maintenance task assignment method is provided. The maintenance task assignment method includes the following steps. An assignment filtering module receives a task list including a maintenance case. The assignment filtering module searches a number of past maintenance records in an assignment database based on the maintenance case to obtain a candidate team leader list based on the past maintenance records. A team management module receives a selection command for a designated team leader chosen from the candidate team leader list. The team management module instructs a code generation module to generate a group code based on a team leader identity data entry in response to verifying that the selection command for the designated team leader matches the team leader identity data entry sent from a first user device of the designated team leader. The group code is displayed on the first user device of the designated team leader, allowing the group code to be scanned by a number of second user devices of team members to form a task team.

According to a third aspect of the present invention, a non-transitory computer readable medium is provided. The non-transitory computer readable medium store program code, executable by a computing device or computer, for performing the maintenance task assignment method mentioned above.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of the system architecture for a maintenance task assignment system which includes the maintenance task assignment device according to an embodiment of the disclosure.

FIG. 2 is a flowchart illustrating the maintenance task assignment method according to an embodiment of the disclosure.

FIG. 3 is a flowchart of the first sub-method illustrating the process of generating the group code in step S17 of FIG. 2.

FIG. 4 is a flowchart of the second sub-method illustrating the process of transmitting the encryption key in step S17 of FIG. 2.

FIG. 5 is a flowchart of the third sub-method of the process of setting up the task team in step S18 of FIG. 2.

### DETAILED DESCRIPTION

The following embodiments provide a maintenance task assignment device and method, and non-transitory computer readable medium. In the maintenance task assignment method, a designated team leader for the task team is first selected. Team members are recruited by providing the group code to the first user device of the designated team leader. Team members can scan the group code displayed on the first user device of the designated team leader by using the second user devices of the team members to complete team formation. This method saves the time traditionally spent for finding team members, improves the efficiency for team grouping, and enhances the accuracy of maintenance technician assignment.

The various embodiments of the disclosure will be described in detail below with reference to the figures as examples. Besides these detailed descriptions, the disclosure can also be applied broadly to other embodiments, and any substitutions, modifications, or equivalent changes of these embodiments fall within the scope of this disclosure, based on the claims. In this specification, to give the reader a more comprehensive understanding of the disclosure, many specific details and examples are provided; however, these specific details and examples should not be considered limitations of the disclosure. Additionally, commonly known steps or components are not described in detail to avoid unnecessary limitation on the disclosure. In the drawings, identical or similar symbols are used to represent identical or similar components.

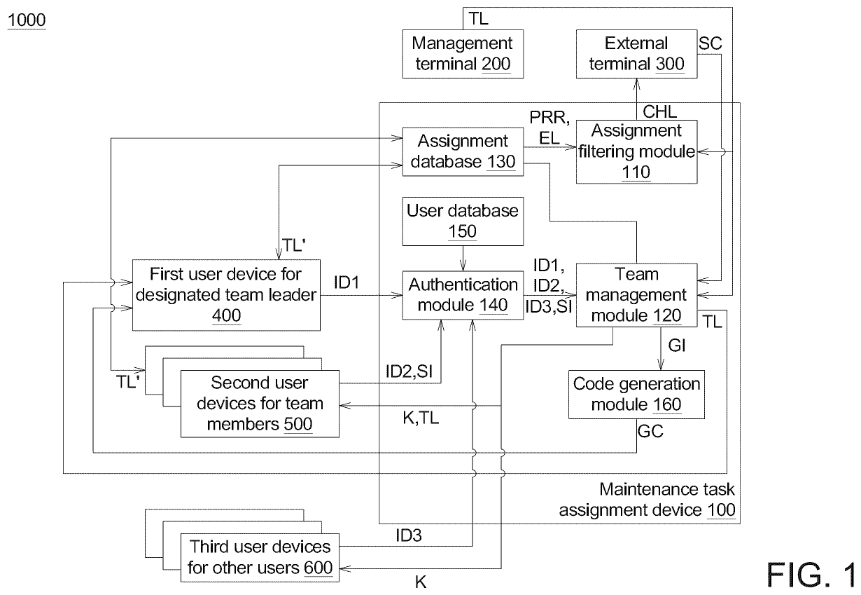

FIG. 1 is a schematic diagram of the system architecture for a maintenance task assignment system 1000 which includes the maintenance task assignment device 100 according to an embodiment of the disclosure.

Referring to FIG. 1, the maintenance task assignment device 100 includes an assignment filtering module 110, a team management module 120, an assignment database 130, an authentication module 140, a user database 150, and a code generation module 160. The assignment database 130 is communicatively connected to the assignment filtering module 110 and the team management module 120. The authentication module 140 is communicatively connected to the team management module 120 and the user database 150. The code generation module 160 is communicatively connected to the team management module 120.

Specifically, the maintenance task assignment device 100 can be established on the same (or different) servers (e.g., general-purpose servers, file servers, storage unit servers) and computers (e.g., personal computers, laptops, tablets) or other electronic devices with suitable computational mechanisms. The modules in the maintenance task assignment device 100 can be software, hardware, or firmware. When the modules are hardware, the modules can be implemented by processing units, processors, computers, or servers with data processing and computing capabilities. When the modules are software or firmware, the modules can be implemented by executable instructions for a processing unit, processor, computer, or server and can be installed on the same hardware device or distributed across a number of hardware devices. Furthermore, the assignment database 130 and the user database 150 can be implemented by hard drives (e.g., mechanical hard drives, solid-state drives), memory, other storage devices, or combinations of these devices.

In this embodiment, the maintenance task assignment device 100 allows a management terminal 200 to set a task list TL based on repair requirements. The task list TL is used by an external terminal 300 to select a designated team leader for a task team. The gathering of team members is conducted based on the team leader, and the team is organized based on the attendance status of each member.

The maintenance of a streetlight is taken as an example, and this example does not limit the application of the maintenance task assignment system 1000, which includes the maintenance task assignment device 100. Specifically, as shown in FIG. 1, the management terminal 200 could be a road maintenance unit that primarily receives repair requests from the public. The external terminal 300 could be a streetlight maintenance company that hires a number of maintenance technicians and provides necessary number of maintenance technicians on-site for maintenance tasks. Each maintenance technician may have their own user device, for example, a first user device 400 for the designated team leader, a number of second user devices 500 for team members, and third user devices 600 for other users.

In one embodiment, the first user device 400 for the designated team leader, the second user devices 500 for the team members, and the third user devices 600 for other users may include, and not limited to, smartphones, tablets, laptops, or other electronic devices with appropriate computing capabilities. Each device can have an application (APP) installed, enabling interaction with the maintenance task assignment device 100 through a user interface (UI) in the APP. The first user device 400 for the designated team leader, the second user devices 500 for team members, and the third user devices 600 for other users can be communicatively connected to the maintenance task assignment device 100 via wired or wireless communication signals, and this is not limited by the disclosure.

In one embodiment, the assignment database 130 stores a number of past maintenance records PRR and an employee list EL, etc. The past maintenance records PRR include the team leader and team members of the task team, maintenance time, maintenance area, maintenance address, maintenance items, maintenance reports, and failure causes, for example. The user database 150 stores user data registered through the user interface, allowing the authentication module 140 to verify the identity data entry of the logged-in user.

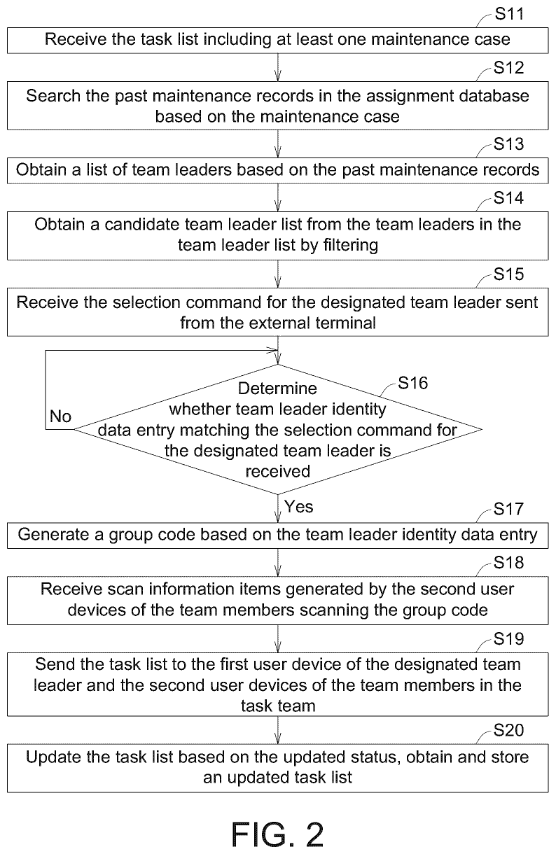

FIG. 2 is a flowchart illustrating the maintenance task assignment method according to an embodiment of the disclosure. This method, described with reference of FIG. 1, includes the following steps.

In step S11, the assignment filtering module 110 and the team management module 120 receive the task list TL set by the management terminal 200. The task list TL includes at least one (such as one or a number of) maintenance case(s). Each maintenance case includes information relevant to the maintenance, such as the maintenance area, maintenance address, maintenance items, maintenance report, and cause of failure.

In step S12, the assignment filtering module 110 searches the past maintenance records PRR in the assignment database 130 based on the maintenance case.

In one embodiment, the assignment filtering module 110 searches relevant past maintenance records PRR based on the maintenance area of the maintenance case. For example, when the maintenance area for the maintenance case is “Songshan District, Taipei City,” the assignment filtering module 110 searches the past maintenance records PRR with the maintenance area “Songshan District, Taipei City.”

In step S13, the assignment filtering module 110 obtains a list of team leaders based on the past maintenance records PRR. For example, the assignment filtering module 110 gathers a list of team leaders who have previously conducted maintenance task in “Songshan District, Taipei City” based on the past maintenance records PRR to form a team leader list based on the team leaders.

In one embodiment, the assignment filtering module 110 further verifies the employment status of the team leaders in the team leader list based on the employee list EL in the assignment database 130. The assignment filtering module 110 further updates the team leader list based on the in-service team leaders and excludes any team leaders who are no longer employed.

In step S14, the assignment filtering module 110 obtains a candidate team leader list CHL from the team leaders in the team leader list based on the past maintenance records PRR as filtering criterion, providing the candidate team leader list CHL to the external terminal 300 for selection.

In one embodiment, the filtering criteria may include at least one of the number of cases handled in the area by the team leaders, average maintenance time, attendance days of the current month, and the number of cases undertaken on the current day. For example, the assignment filtering module 110 may conduct a number of rounds of filtering based on the filtering criteria of the number of cases handled in the area by the team leaders, average maintenance time, attendance days of the current month, and the number of cases undertaken on the current day.

Specifically, the assignment filtering module 110 first sorts the team leaders by the number of cases handled in the area, from most to least, and then selects a number of first candidate team leaders based on a first sub-filtering criterion (such as the top 70% in ranking). Next, the assignment filtering module 110 sorts these first candidate team leaders by average maintenance time, from shortest to longest, and selects a number of second candidate team leaders based on a second sub-filtering criterion (such as the top 50% in ranking). The assignment filtering module 110 then sorts the second candidate team leaders by attendance days in the current month, from most to least, and selects at least one (e.g., one or multiple) third candidate team leader(s) (such as the top 1 to 3) from the second candidate team leaders with fewer cases handled than the daily maximum limit. This set of third candidate team leader(s) forms the candidate team leader list CHL, which may include a number of recommended candidates or a single recommendation, and the disclosure is not limited thereto. The candidate team leader list CHL is then provided to the external terminal 300 for selection, or the assignment filtering module 110 may directly recommend a single designated team leader to the external terminal 300.

In step S15, when the external terminal 300 selects a designated team leader from the candidate team leader list CHL, the team management module 120 receives the selection command SC for the designated team leader sent from the external terminal 300.

In step S16, the team management module 120 determines whether the team management module 120 receives team leader identity data entry ID1 matching the selection command SC for the designated team leader. When the team leader identity data entry ID1 matching the selection command SC for the designated team leader is received, step S17 is executed. Otherwise, when the team leader identity data entry ID1 which does not match the selection command SC for the designated team leader is received, the external terminal 300 is notified to select another designated team leader.

In one embodiment, when the designated team leader logs in the maintenance task assignment device 100 through the user interface of the first user device 400, the first user device 400 of the designated team leader sends the team leader identity data entry ID1 to the authentication module 140. The authentication module 140 then verifies the team leader identity data entry ID1 against the user data entries stored in the user database 150. When the authentication module 140 verifies that the team leader identity data entry ID1 matches one of the user data entries, the authentication module 140 transmits the team leader identity data entry ID1 to the team management module 120. When the team management module 120 confirms that the received team leader identity data entry ID1 matches the selection command SC for the designated team leader, step S17 is entered.

In step S17, the team management module 120 instructs the code generation module 160 to generate a group code GC based on the team leader identity data entry ID1. In one embodiment, the group code GC corresponds to a group information entry GI.

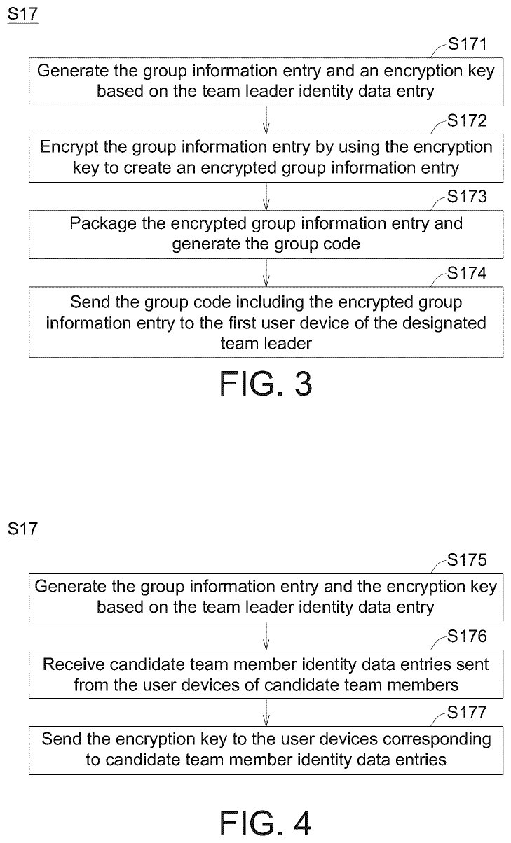

FIG. 3 is a flowchart of the first sub-method illustrating the process of generating the group code GC in step S17 of FIG. 2, as described with reference to FIG. 1. This first sub-method includes the following steps.

In step S171, the team management module 120 generates the group information entry GI and an encryption key K based on the team leader identity data entry ID1.

In step S172, the team management module 120 encrypts the group information entry GI by using the encryption key K to create an encrypted group information entry GI. The encrypted group information entry GI is then transmitted by the team management module 120 to the code generation module 160. In one embodiment, the encryption procedure for the group information entry GI can be symmetric encryption, allowing the encryption key K to be used for encryption and decryption of the group information entry GI. However, the disclosure is not limited thereto.

In step S173, the code generation module 160 generates the group code GC based on the encrypted group information entry GI by packaging the encrypted group information entry GI. The group code GC may be a one-dimensional code (e.g., barcode) or a two-dimensional code (e.g., QR code). This disclosure is not limited thereto.

In step S174, the code generation module 160 sends the group code GC, which includes the encrypted group information entry GI, to the first user device 400 of the designated team leader.

FIG. 4 is a flowchart of the second sub-method illustrating the process of transmitting the encryption key K in step S17 of FIG. 2, as described with reference to FIG. 1. This second sub-method includes the following steps.

In step S175, the team management module 120 generates the group information entry GI and the encryption key K based on the team leader identity data entry ID1.

In step S176, the team management module 120 receives a number of candidate team member identity data entries (including team member identity data entries ID2 and/or other user identity data entry ID3) sent from the user devices (including the second user devices 500 of the members and/or the third user devices 600 of other users) of a number of candidate team members.

In one embodiment, when the a number of candidate team members (including team members and/or other users) log into the maintenance task assignment device 100 through the user interface on the user devices 500 and 600, the user devices 500 and 600 send the candidate team member identity data entries (including the team member identity data entries ID2 and/or other user identity data entry ID3) to the authentication module 140. The authentication module 140 verifies the candidate team member identity data entries against the user data entries stored in the user database 150. When the authentication module 140 confirms that any of the candidate team member identity data entries matches one of the user data entries, the authentication module 140 transmits the matched candidate team member identity data entry/entries to the team management module 120.

In step S177, the team management module 120 sends the encryption key K to the user devices 500 and 600 corresponding to the candidate team member identity data entries (including team member identity data entries ID2 and/or other user identity data entry ID3). For example, the team management module 120 sends the encryption key K to the user devices 500 and 600 corresponding to the candidate team member identity data entries, each of which matches one of the user data entries.

Referring to FIGS. 1 and 2, in step S18, the team management module 120 receives a number of scan information items SI generated by the second user devices 500 of the team members after the second user devices 500 scan the group code GC. The team management module 120 also receives the team member identity data entries ID2 sent from the second user devices 500 of the team members. Based on the team leader identity data entry ID1, the team member identity data entries ID2, and the scan information items SI, the first user device 400 of the designated team leader and the second user devices 500 of the team members are assigned to be a task team.

In one embodiment, the scan information items SI may be the decrypted group information entry GI generated by decrypting the encrypted group information entry GI with using the encryption key K.

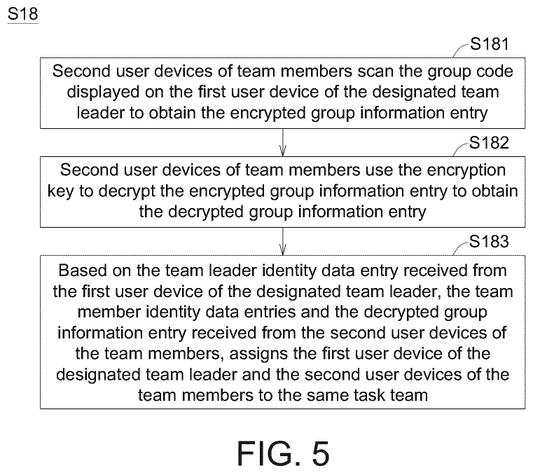

FIG. 5 is a flowchart of the third sub-method of the process of setting up the task team in step S18 of FIG. 2, as described with reference to FIG. 1. This third sub-method includes the following steps.

In step S181, when a number of team members wish to join the same task team, the second user devices 500 of the team members scan the group code GC displayed on the first user device 400 of the designated team leader to obtain the encrypted group information entry GI.

In step S182, the second user devices 500 of the team members can use the previously received encryption key K to decrypt the encrypted group information entry GI to obtain the decrypted group information entry GI. The second user devices 500 then send the decrypted group information entry GI to the team management module 120 through the authentication module 140.

In step S183, based on the team leader identity data entry ID1 received from the first user device 400 of the designated team leader, the team member identity data entries ID2 and the decrypted group information entry GI received from the second user devices 500 of the team members, the team management module 120 assigns the first user device 400 of the designated team leader and the second user devices 500 of the team members to the same task team.

Referring to FIGS. 1 and 2, in step S19, the team management module 120 sends the task list TL to the first user device 400 of the designated team leader and the second user devices 500 of the team members in the task team.

In one embodiment, the team management module 120 also accesses the current location information of the first user device 400 of the designated team leader and the second user devices 500 of the team members. Based on the location information, the team management module 120 sorts the maintenance cases in the task list TL from nearest to farthest. Thus, the task team can perform maintenance tasks in sequence, starting with the maintenance case with the closest location.

In one embodiment, the user interface in the first user device 400 of the designated team leader and the user interface in the second user devices 500 of the team members allows the designated team leader and team members to fill in the details of the maintenance cases in the task list TL.

In step S20, when the team leader and team members fill out the maintenance cases in the task list TL, the first user device 400 of the designated team leader and the second user devices 500 of the team members send the updated status of the task list TL to the assignment database 130. This allows the assignment database 130 to update the task list TL based on the updated status of the task list, obtain and store an updated task list TL′.

In one embodiment, the first user device 400 of the designated team leader and the second user devices 500 of the team members can also access the updated task list TL′ stored in the assignment database 130, enabling each member to track each other's work progress and facilitate team collaboration. Additionally, the updated task list TL′ can be stored as part of the past maintenance records PRR in the assignment database 130.

In one embodiment, the team management module 120 further sets a team duration time for the task team, after which the team is automatically disbanded. For example, the team duration time of the task team may have an upper limit value, for example 12 hours. When the duration time of the task team exceeds 12 hours, the team management module 120 automatically disbands the task team.

In another embodiment, the team duration time of the task team may be set based on the update status of the task list TL. For instance, when the team management module 120 confirms that all maintenance cases in the updated task list TL′ have been completed, the team management module 120 can automatically disband the task team. Alternatively, the team management module 120 can send a disband notification to the first user device 400 of the designated team leader. Upon receiving a confirmation response from the first user device 400 of the designated team leader, the team management module 120 disbands the task team.

Furthermore, the disclosure also discloses a non-transitory computer readable medium applied to computing devices or computers that have a processor (such as a CPU, GPU, etc.) and/or memory, which stores program code that can be executed by the computing device or computer through the processor and/or memory to perform the aforementioned method and its various steps when executing the program code stored in the non-transitory computer readable medium. In one embodiment, the disclosure also discloses a non-volatile computer readable medium to execute the aforementioned method and various steps thereof.

In summary, the maintenance task assignment device and method, and non-transitory computer readable medium of the disclosure primarily display a group code formed by an encrypted group information entry on a first user device of a designated team leader, which is provided for being scanned by a number of second user devices of team members. This enables flexible addition of the team leader and team members into the same task team. Compared to the prior art, which requires human scheduling to form a task team, the disclosure can quickly add candidate members to the same task team with the team leader through a group code formed by the encrypted group information entry, significantly enhancing assignment efficiency and improving the accuracy of manpower assignment.

Additionally, the disclosure further pre-verifies the identity data entries of a number of candidate members (including team members and other users) and provides an encryption key to all verified candidate members. This allows team members among a number of candidates to quickly join the task team after scanning the group code formed by the encrypted group information entry.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A maintenance task assignment device, comprising:
an assignment database, configured to store a plurality of past maintenance records;
an assignment filtering module, configured to be communicatively connected to the assignment database to receive a maintenance case in a task list, and search the past maintenance records in the assignment database to obtain a candidate team leader list based on the past maintenance records;
a code generation module, configured to generate a group code; and
a team management module, configured to be communicatively connected to the code generation module and receive a selection command for a designated team leader chosen from the candidate team leader list, wherein the team management module instructs the code generation module to generate the group code based on a team leader identity data entry in response to verifying that the selection command for the designated team leader matches the team leader identity data entry sent from a first user device of the designated team leader, and the group code is displayed on the first user device of the designated team leader, allowing the group code to be scanned by a plurality of second user devices of a plurality of team members to form a task team.

2. The maintenance task assignment device according to claim 1, wherein the team management module receives corresponding scan information items generated by the second user devices of the team members after the second user devices scan the group code, and the team management module receives identity data entries of the team members sent from the second user devices of the team members; wherein based on the team leader identity data entry, the identity data entries of the team members, and the scan information items, the team management module sets the first user device of the designated team leader and the second user devices of the team members as the task team.

3. The maintenance task assignment device according to claim 1, wherein the team management module generates a group information entry and an encryption key based on the team leader identity data entry, and encrypts the group information entry by using the encryption key to generate an encrypted group information entry, the code generation module subsequently generates the group code according to the encrypted group information entry.

4. The maintenance task assignment device according to claim 3, wherein the code generation module transmits the group code including the encrypted group information entry to the first user device of the designated team leader, and the team management module transmits the encryption key to the second user devices of the team members, and wherein the scan information item is the group information entry obtained by decrypting the encrypted group information entry by using the encryption key.

5. The maintenance task assignment device according to claim 4, wherein the assignment filtering module further provides the candidate team leader list to an external terminal for selection, and the team management module receives the selection command for the designated team leader chosen from the candidate team leader list from the external terminal.

6. The maintenance task assignment device according to claim 1, wherein the team management module sends the task list to the first user device of the designated team leader in the task team and the second user devices of the team members in the task team.

7. The maintenance task assignment device according to claim 6, wherein the assignment database stores an updated task list based on an update status of the task list inputted from the first user device of the designated team leader in the task team and the second user devices of the team members in the task team.

8. The maintenance task assignment device according to claim 7, wherein the team management module sets a team duration time for the task team, the team duration time has an upper limit value or is set based on the update status of the task list.

9. The maintenance task assignment device according to claim 1, wherein the assignment filtering module obtains a team leader list based on the past maintenance records, and further obtains the candidate team leader list from the team leaders in the team leader list according to a filtering criterion based on the past maintenance records, and wherein the filtering criterion includes at least one of a number of cases handled in an area by the team leaders, average maintenance time, attendance days of a current month, and a number of cases undertaken on a current day.

10. The maintenance task assignment device according to claim 9, wherein the assignment filtering module confirms employment status of the team leaders in the team leader list based on an on-duty employee list in the assignment database and updates the team leader list based on on-duty status of the team leaders.

11. A maintenance task assignment method, comprising:
receiving, by an assignment filtering module, a task list including a maintenance case;
searching, by the assignment filtering module, a plurality of past maintenance records in an assignment database based on the maintenance case to obtain a candidate team leader list based on the past maintenance records; and
receiving, by a team management module, a selection command for a designated team leader chosen from the candidate team leader list, wherein the team management module instructs a code generation module to generate a group code based on a team leader identity data entry in response to verifying that the selection command for the designated team leader matches the team leader identity data entry sent from a first user device of the designated team leader, and the group code is displayed on the first user device of the designated team leader, allowing the group code to be scanned by a plurality of second user devices of a plurality of team members to form a task team.

12. The maintenance task assignment method according to claim 11, further comprising:
receiving, by the team management module, corresponding scan information items generated by the second user devices of the team members scanning the group code, and receiving identity data entries of the team members sent from the second user devices of the team members; and
setting, by the team management module, the first user device of the designated team leader and the second user devices of the team members as the task team based on the team leader identity data entry, the identity data entries of the team members, and the scan information items.

13. The maintenance task assignment method according to claim 11,
wherein the step that the team management module instructs the code generation module to generate the group code comprises:
generating, by the team management module, a group information entry and an encryption key based on the team leader identity data entry;
encrypting, by the team management module, the group information entry by using the encryption key to generate an encrypted group information entry; and
generating, by the code generation module, the group code according to the encrypted group information entry.

14. The maintenance task assignment method according to claim 13, further comprising:
transmitting, by the code generation module, the group code including the encrypted group information entry to the first user device of the designated team leader; and
transmitting, by the team management module, the encryption key to the second user devices of the team members;
wherein the scan information item is the group information entry obtained by decrypting the encrypted group information entry by using the encryption key.

15. The maintenance task assignment method according to claim 14, further comprising:
providing, by the assignment filtering module, the candidate team leader list to an external terminal for selection; and
receiving, by the team management module, the selection command for the designated team leader chosen from the candidate team leader list from the external terminal.

16. The maintenance task assignment method according to claim 11, further comprising:
sending, by the team management module, the task list to the first user device of the designated team leader in the task team and the second user devices of the team members in the task team.

17. The maintenance task assignment method according to claim 16, further comprising:
storing, by the assignment database, an updated task list based on an update status of the task list inputted from the first user device of the designated team leader in the task team and the second user devices of the team members in the task team.

18. The maintenance task assignment method according to claim 17, further comprising:
setting, by the team management module, a team duration time for the task team, wherein the team duration time has an upper limit value or is set based on the update status of the task list.

19. The maintenance task assignment method according to claim 11, wherein the step of obtaining the candidate team leader list by the assignment filtering module based on the past maintenance records comprises:
obtaining, by the assignment filtering module, a team leader list based on the past maintenance records;
obtaining, by the assignment filtering module, the candidate team leader list from the team leaders in the team leader list according to a filtering criterion based on the past maintenance records, wherein the filtering criterion includes at least one of a number of cases handled in an area by the team leaders, average maintenance time, attendance days of a current month, and a number of cases undertaken on a current day.

20. The maintenance task assignment method according to claim 19, further comprising:
confirming, by the assignment filtering module, employment status of the team leaders in the team leader list based on an on-duty employee list in the assignment database and updating the team leader list based on on-duty status of the team leaders.

21. A non-transitory computer readable medium storing program code, executable by a computing device or computer, for performing the maintenance task assignment method according to claim 11.
